(19) United States
(12) Patent Application Publication
(10) Pub. No.: US 2025/0235964 A1
(43) Pub. Date: Jul. 24, 2025

(54) Fastener Feeder Head

(71) Applicant: Penn Engineering & Manufacturing Corp., Danboro, PA (US)

(72) Inventors: Wouter Kleizen, Langeveen (NL); Florian Petry, Flörsheim am Main (DE); Lars Dreßler, Altenstadt (DE)

(21) Appl. No.: 19/016,397

(22) Filed: Jan. 10, 2025

Related U.S. Application Data
(60) Provisional application No. 63/622,757, filed on Jan. 19, 2024.

(51) Int. Cl. B23P 19/00; B23P 19/06

(52) U.S. Cl. CPC B23P 19/003; B23P 19/062

(57) ABSTRACT

A feeder device for a punch press moves nuts on the carrier strip from a supply reel into the feeder which then presents them for delivery to the workpiece insertion site. The punch of the press picks each individual fastener from the feeder and delivers it to a workpiece below where the punch presses the nut into the workpiece. The feeder only requires a press with downwardly applied force and requires no additional energy source for its operation other than that transmitted by the downward force of the press. A drive mechanism of the feeder is powered by a camming action against the press punch which rotates a fastener-engaging feed wheel to advance the carrier strip into and through the feeder. A bifurcated feed track separates fasteners from the carrier strip and delivers the loose fasteners into the feed wheel which positions them at a pickoff site.

### FIELD OF THE INVENTION

The invention relates to industrial fastener installation heads which possess fastener feeding capabilities. It relates to feeders of the type that pull a series of fasteners held on a carrier strip from a bulk source to an installation site where the fastener is attached to a workpiece.

### BACKGROUND OF THE INVENTION

Mechanical fasteners are most often processed on insertion machines. To accomplish this, a workpiece is positioned by an operator manually, or alternatively a robot, under a press that is equipped with an appropriate insertion tool to attach the fastener to the workpiece.

Some problems in this field are that manual feeding is time consuming and automated feeding of the fasteners to the installation tool needs to be set up for each different fastener which is only cost efficient for high volume production quantities. Carrier strips are often used to enhance the feeding process but require adhesives or produce scrap waste that is difficult to handle and dispose. Further, some feeders require their own power source that must be coordinated with the insertion tool, or the tool itself must be individually powered. These solutions are complicated and costly.

There is therefore a need for press tooling which is self-actuating and which feeds fasteners from a supply strip to an insertion site. There is also a need for such a device which is efficient, uncomplicated, and economical to employ.

### SUMMARY OF THE INVENTION

The present fastener feeder has been devised to overcome the deficiencies in the art and meet the needs described above. The feeder of the invention receives a supply of fasteners held on a flexible carrier strip of indeterminate length and delivers them to an insertion site with the workpiece without the need for a separate power source or a controller.

In one embodiment, nuts on the carrier strip are fed from a supply reel into the feeder which then presents them for delivery to the workpiece insertion site. The insertion device in this case is a punch press. The punch of the press picks each individual fastener from the feeder and delivers it to a workpiece below where the punch presses the nut into the workpiece. A punch assembly includes a retraction spring to speed the return reciprocal action of the punch and thus only requires a press with downwardly applied force. As will be further described below, the present feeder device requires no additional energy source for its operation other than that provided by the downward force of the press transmitted to the feeder device.

A main component of the feeder is a feed wheel which takes the fasteners one at a time from the carrier strip and delivers them to a pickoff site by rotation of the wheel. The feed wheel is rotatably mounted to a bottom member base of the feeder framework which in turn is rigidly secured to a frame of the punch press. The wheel has radially-extending teeth formed with containment pockets between each tooth which hold a fastener taken from the carrier strip. A spring-biased catch operates against the backside of the teeth to ensure that the feed wheel will not counter-rotate and thus can turn only in the forward direction. The wheel is turned intermittently by a resilient pawl of a feed wheel drive mechanism slidably affixed to the feeder framework suspended above the feed wheel. Acting together, these components form an escapement which drives the wheel intermittently in one direction only.

The feed wheel drive mechanism includes a drive block that is spring-biased toward the press punch. The drive block is moved by punch contact with a camming end surface of the drive block which is driven laterally by the end of the punch as it moves downward. By these mechanical relations the drive assembly reciprocates between advanced and retracted positions along a horizontal line orthogonal to the punch axis in coordination with the punch as it moves up and down.

More specifically, the invention may be described as a fastener feed device for nuts installed by a punch press. The feed device comprises a framework attached to the punch press and having a vertical bore at a top end for receiving a punch of said punch press. The bore is in alignment with a pickoff site within the feed device where the fasteners are picked off and then installed into a workpiece by the punch.

A feed track in the framework of the feed device receives a plurality of fasteners held on a carrier strip that are moved to a feed wheel rotatably affixed to the framework. The track is a composite of two tracks, one for the carrier strip and one for the fasteners. The tracks are at first superimposed but then diverge such that the loose nuts are removed from the strip at this separator portion of the feed track. As the loose nuts continue along the track, they are delivered to a plurality of feed wheel containment pockets located between each of the teeth which hold individual loose fasteners removed from the carrier strip. The feed wheel has radial teeth which individually engage the fasteners on the carrier strip in the feed track whereby the feed wheel is operative to pull said carrier strip to successive positions of advancement along the track.

The feed wheel is turned by a drive mechanism slidably captive within the feed device framework and is operative to turn said feed wheel in an intermittent ratcheting fashion. The individual loose fasteners occupy the feed wheel containment pockets and are delivered to a pickoff site by the feed wheel. An important component of the drive mechanism is a spring disposed between the framework and the drive mechanism to forceably bias the drive mechanism into engagement with the press punch. The drive mechanism comprises a reciprocal drive block that intermittently turns the feed wheel. The drive block has a cam surface on a distal end that engages the press punch. Thereby the vertical up and down motion of the punch causes concomitant horizontal back and forth motion of the drive block between extended and retracted positions.

The drive block is closely held above the feed wheel and within walls of the framework which closely bound its reciprocal path. One of the walls is a framework intermediate member which supports the bottom of the drive block. It has a slot through which the drive block pawl extends downwardly. The pawl provides a ratcheting action to the feed wheel by engaging lugs on the top of the feed wheel one-at-a-time.

From the following drawings of one embodiment of the feeder device of the invention, it will be observed how the carrier strip is advanced as the drive wheel teeth successively engage one fastener at a time as it simultaneously pulls the strip forward. Fasteners are taken from the strip and delivered to an insertion position by the intermittent rotation of the wheel powered only by the action of the punch. Yet greater detail of one embodiment of the invention is described by the following figures of drawing and description of its various components and how they operate to feed fasteners from a carrier strip to an installation site where the fasteners can be affixed to a workpiece. From this description it will be apparent to one of skill in the art that the stated objects of the invention have been achieved.

### BRIEF DESCRIPTION OF THE DRAWINGS

FIG. 1 is a top left front isometric view of the fastener feeder of the invention.

FIG. 2 is a left side isometric view of some internal components thereof.

FIG. 3 is a top rear isometric view taken from FIG. 2.

FIG. 4 is a top plan view showing the drive wheel assembly.

FIG. 5 is a right front isometric view of the drive assembly in the advanced position.

FIG. 6 is a right front isometric view of the drive assembly in the retracted position.

FIG. 7 is a left side elevation sectional view thereof.

FIG. 8 is a top front left isometric assembly isometric assembly view thereof.

FIG. 9 is an illustration which depicts a representative sectional view of the feed track.

### DESCRIPTION OF ONE EMBODIMENT OF THE INVENTION

The following is a description of the elements of the invention in conjunction with the enumerated drawings. The terms “up” and “down” are opposite directions in a vertical plane parallel to the press punch axis corresponding to the retracted and expended positions of the punch, respectively. The term “horizontal” shall mean the direction orthogonal to the punch axis. Likewise. the terms “top” and “bottom” shall refer to ends of the components consistent with the foregoing definition of terms “up” and “down”.

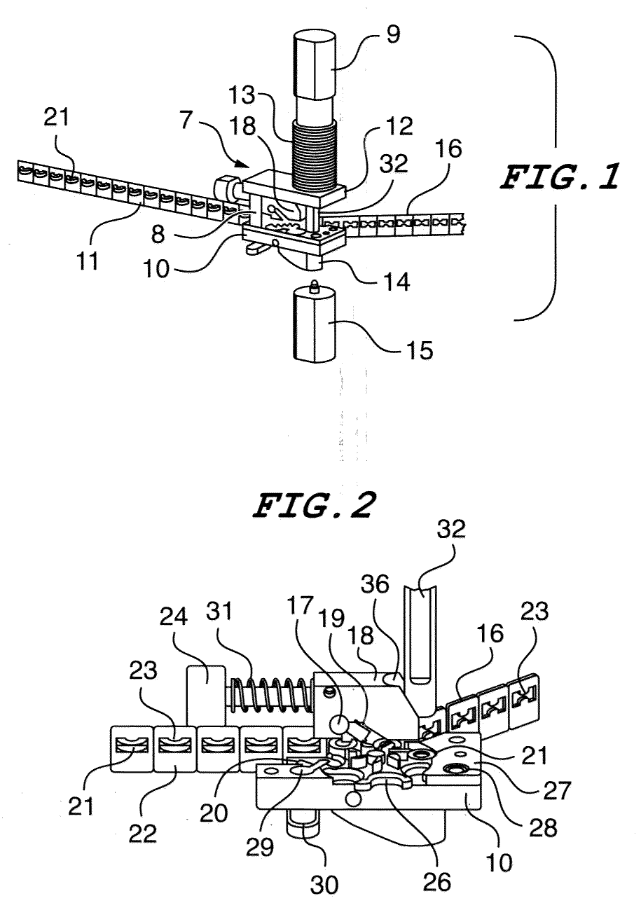

Like enumeration of the same component parts of the embodiment of the invention is used throughout the following various figures of drawings. As such, the drawings are to be viewed collectively with specific reference to the figures individually. As explained, various members of the device framework comprising the invention have been removed from some drawing figures to better depict the inner workings of the invention which they would otherwise obscure. The complete invention is seen in figures of drawing 7 and 8 which show framework structures 83 and 85 that are absent from FIGS. 1 through 6 so that the operative internal components of the device can be viewed.

Referring now to FIG. 1, a general overview of one embodiment of the invention shows a series of nuts 21 mounted on a carrier strip 11 that enter the feeder 7 of the invention through end member 8. A punch retraction spring 13 operates against a press punch 9 which not only installs the nuts but also actuates the feed device. As will be later explained, the punch tip 32 picks individual fasteners from the feeder and installs them into a workpiece (not shown) positioned between a nose piece 14 of the feeder and an anvil 15 of the punch press. Further details of the punch press need not be explained for a complete understanding of the invention as it could be any well known in the industry such as a C-frame hydraulic punch press. The feeder device of the invention is affixed to the frame of the punch press. The punch retraction spring 13 is mounted to the top of the feed device to speed the return action of the punch so that a single-action press limited to a downwardly applied force can be employed.

In part, the framework of the feeder includes top member 12, bottom base member 10 and a vertical end member 8 which extends between those two members. The press punch 9 bears against a top member 12 of the feeder framework through retraction spring 13. A bottom member 10 of the framework holds the feeder drive means 18 and forms part of a track which supports and separates the nuts from the carrier strip as explained below. The vacant remainder carrier strip 16 with the nuts removed by the feeder is pushed by the carrier strip from the feeder to be discarded or preferably recycled.

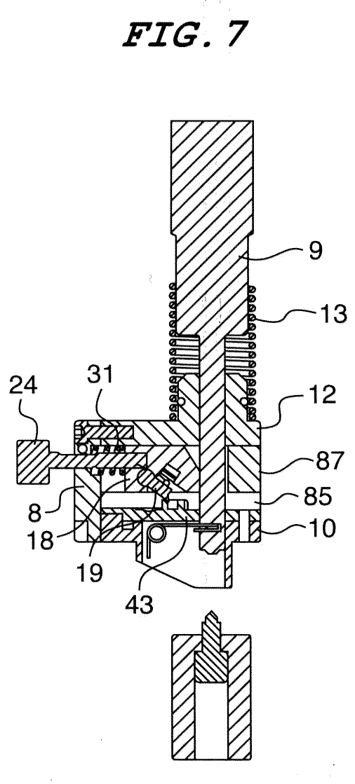

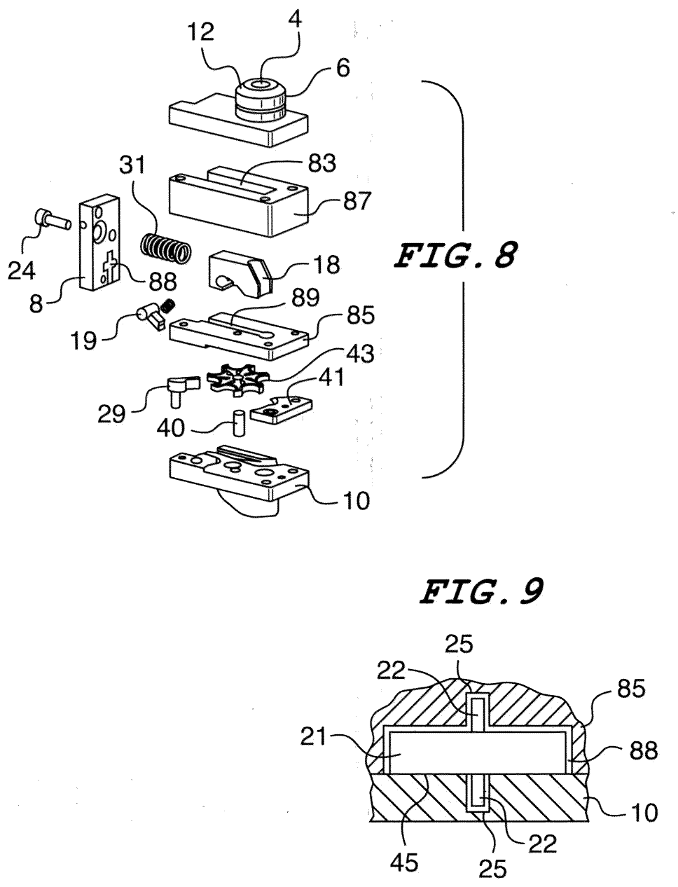

Referring now to FIG. 2, enclosing framework members seen in FIGS. 7 and 8 are removed here for sake of illustrating the internal working components of the invention. Each nut 21 is held only by opposing top and bottom flexible tabs 23 of the carrier strip material which for example may be a flexible plastic. Here, the tabs extend into an internal bore of each fastener 21 and are axially more rigid while being laterally deflectable. In one embodiment of the invention these functional elements of the strip are formed by cutting openings in a strip blank for ease of manufacture of the strip.

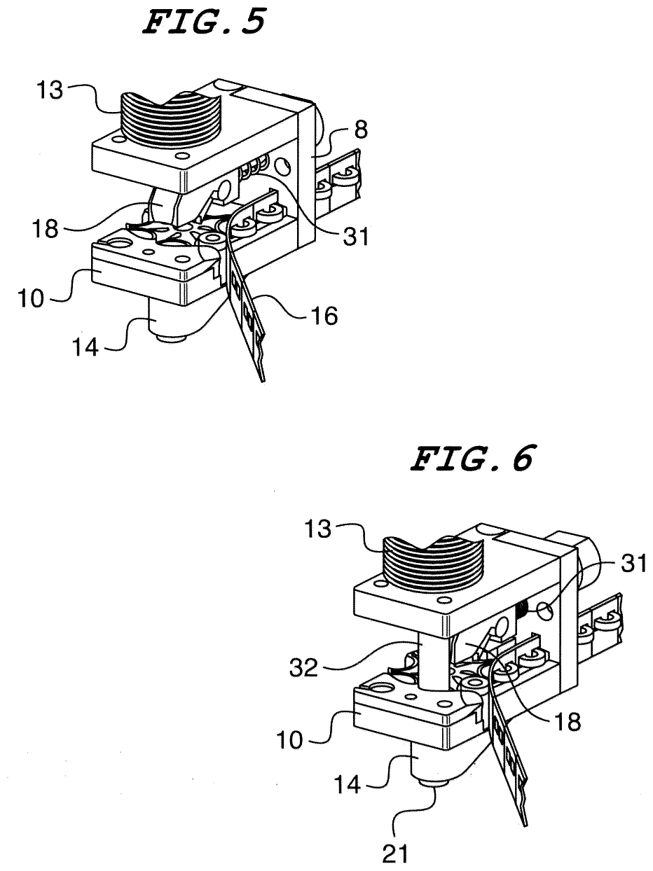

A feed wheel 26 is central to the operation of the feeder. It receives individual loose fasteners from the carrier strip and delivers them to a pickoff position located directly under the press punch tip 32 axis (line of action). The force of the feed wheel acting upon the nuts drives the entire carrier strip into and out of the feeder by the axial engagement of the nuts with the strip which in turn moves the entire strip. A feed wheel drive block 18 transfers the reciprocal action of the punch 32 to the wheel causing the intermittent rotation of the feed wheel. The drive block is slidably affixed within a housing of the greater feeder framework removed here but seen in FIGS. 7 and 8 as framework housing member 87. The drive block slides along a substantially horizontal path suspended above the feed wheel by an intermediate framework member 85 shown FIG. 8. The feed wheel drive block 18 is spring-biased toward the punch tip 32 by spring 31 which operates between the drive block body and the vertical member frame member 8 seen in FIGS. 1, 7 and 8. The drive block 18 receives its motive force from an obliquely angled camming end surface 36 which is driven laterally away from the punch axis by contact with the end of the punch tip as the punch 32 moves downward. The camming surface 36 is beveled to match the shape of the punch tip. By these relations the drive assembly reciprocates between extended and retracted positions along a horizontal line orthogonal to the punch axis in coordination with the punch as it moves up and down. These positions of the drive assembly are illustrated in FIGS. 5 and 6.

With further reference to FIG. 2, the drive mechanism including drive block 18 turns the feed wheel 26 by a pawl 17 that engages one of several upwardly extending drive lugs on the top of the wheel 26 (as better seen in FIG. 4). The end of the drive pawl 17 fits between the wheel lugs, turning it incrementally to successive ratcheting positions of advancement. The pawl 17 is deflectable vertically and is downwardly biased by a spring 19 fully compressed in this view. During its operation, the drive assembly is driven in the extended direction by spring 31 and moves the pawl along a path tangential to the wheel. The end of the pawl rides along the top surface of the wheel engaging the upwardly extending lugs on the wheel one at a time. After turning the wheel during the subsequent retraction of the drive block the pawl skips behind the next lug to complete its working cycle.

The drive mechanism operates as follows. When the drive mechanism is retracted by the downward moving punch tip, it force-loads spring 31. During this retraction phase of operation, the drive pawl deflects upwardly against the pressure of spring 19 moving over the next wheel lug to a position behind it ready for the next forward push by the drive block pawl 17. A spring-biased catch 29 (as better seen in FIG. 4) operates against the backside of the wheel teeth to ensure that the wheel cannot counter-rotate. The catch includes arm 29 and a spring 20. It rotates on an axle in the bottom plate 10 that has an extending lever 30 for manual operation of the catch. The catch resiliently deflects to move behind the next tooth as the wheel turns. This ratcheting action of the catch is similar in function to the drive pawl except that the former is active while the latter is passive. The pawl and catch combine to form and escapement by which the feed wheel is intermittently driven in one direction only. A plunger 24 affixed to the drive block 18 extends from the drive mechanism. This permits the manual operation of the drive mechanism as may be required during the initial loading of the carrier strip assembly into the feeder. In this figure we see a fastener 21 captured in one of the feed wheel pockets which as further described below now occupies the pickoff site in axial alignment with the punch 32. In this position the nut fastener is grasped against the drive wheel by a clamp jaw 27 biased toward the drive wheel by spring 28. From this pickoff position it will be picked off during the next downward movement of the punch.

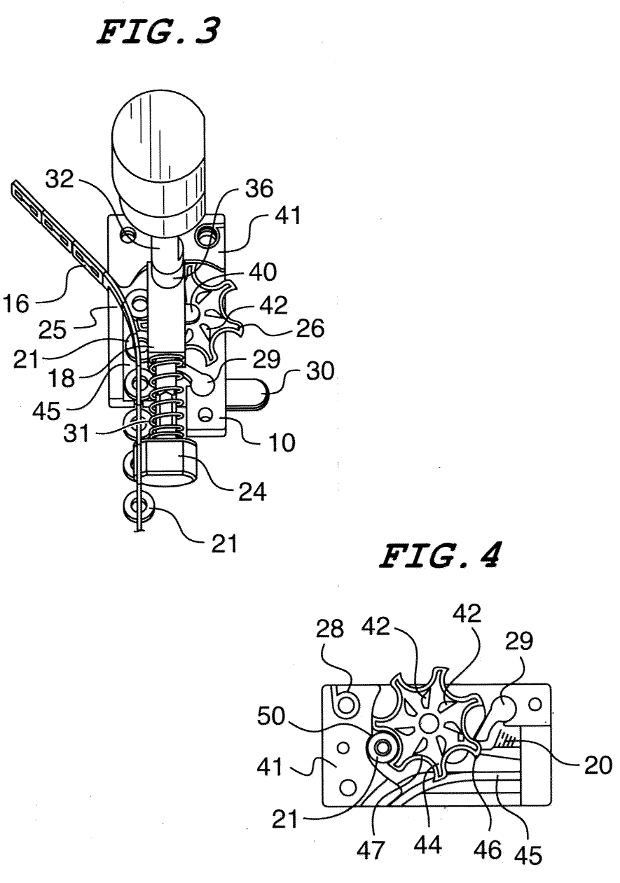

Referring now to FIG. 3, as described above the feed wheel takes the fasteners 21 one at a time from the carrier strip 11 and delivers them to a pickoff site by rotation of the wheel. The drive wheel 26 is rotatably mounted to the base member 10 of the feeder framework by axle 40. As better seen in FIG. 4, the wheel has radially-extending teeth constructed with containment pockets between successive teeth that each holds a fastener such as a nut shown here. From this view it can readily be seen that the line of action of the drive mechanism 18 is offset from the rotational axis of the drive wheel so that the drive pawl operates on the lugs 42 of wheel 26 tangentially to turn it. The plunger 24 is affixed to the drive block 18 to manually operate on the drive assembly as needed. Similarly, lever arm 30 is connected to the counter-rotation pawl 29 so that the wheel can be manually counter rotated. Also seen here is the contact between the camming end surface 36 of the drive block 18 with the punch 32.

Referring now to FIG. 9, The carrier strip/nut combination enters the feed device along a feed track through the end member. The track is a composite structural configuration of two elements, a main pathway channel 88 and a slot 25. The slot is constructed to direct the strip and the main pathway channel is for directing the nuts. This illustration depicts the configuration of the feed track upstream of the separation point where the components later diverge. Here, the main pathway holds the fasteners 21 of the nut/carrier strip assembly which is supported by a top surface 45 of the bottom member 10. At the track entrance seen here, the two track elements are superimposed. The slot 25 which guides the carrier strip is eclipsed by the main pathway which divides it into two opposing slots, one in the framework member 85 and the other in the bottom base member 10.

With continued reference to FIG. 3, the nuts are removed from the carrier strip by a bifurcation of the two elements of the feeder track 45 as described above regarding FIG. 9. This occurs along a separation portion of the feed track 45 upon which the nut/strip assembly rides. As the carrier strip assembly progresses through the feeder, the strip guiding slot 25 which directs the path of the carrier strip diverges laterally from the line of the fastener track 45 sidewalls that direct the nuts. The strip slot component of the track is a greatly narrowed part of the track forming slots in the surrounding members above and below the main track pathway that contains the nuts. The track slots receive the carrier strip while blocking passage of the nuts. As the carrier strip advances along the pathway, the strip guide track diverges through a sidewall of the main track causing the carrier strip slots 25 to apply a lateral wedging force to the carrier strip relative to the nuts. This action causes the nuts to be wedged apart from the strip assembly since they are only mounted to the strip by flexible tabs. The result is a row of loose nuts that then enter containment pockets of the feed wheel. Continued advancement of the carrier strip assembly forces the vacant remainder of the strip 16 to be forced from feed device.

Referring to FIG. 4, the operation of the feeder is aided by a spring-biased clamp jaw 41 rotatably affixed to the top of the feeder bottom member 10. The clamp jaw 41 is rotatable about a pin and resiliently biased by spring 28 in the plane of the wheel. The jaw has an arcuate surface that forms part of the main channel pathway sidewall. It provides rotational stability to the wheel by friction with the ends 46 of the wheel teeth 44 while it presses each fastener 21 against the inner surface of one of the wheel containment pockets 47. Seen here, the fastener has progressed along track 45 and reached the pickoff site. To positively establish this pickoff position, the clamp jaw plate has an arcuate ridge 50 located at the pickoff site which acts as a stop to prevent farther advancement of the fastener. This action of the clamp jaw 41 grasps each fastener 21 delivered to the pickoff position and holds it until it is forced out of its grasp to be picked off by the descending punch for installation into the workpiece below. As previously explained, the feed wheel is driven by force applied to lugs 42 one at a time. Counterrotation of the wheel is prevented by catch 29 which is biased by spring 20.

Referring to FIGS. 5 and 6, the two extreme positions of the drive mechanism are shown. In FIG. 5 the drive mechanism is seen in its fully extended position being spring-biased against the end of the punch with the punch in its upwardly retracted position aided by spring 13. In achieving this position, the drive block has turned the feed wheel which advanced the nuts to the pickoff site seen in FIG. 4 and has driven the vacant remainder carrier strip 16 from the feed device. Here, the drive mechanism is fully extended by the force of spring 31 which operated between the drive block 18 and the end member 8. Here the punch has been retracted and the punch retraction spring 31 is in its more relaxed state. The feed wheel has fully advanced a nut into the pickoff position on bottom plate 10 waiting for the next downward stroke of the punch to drive the nut down through nose piece 14. This process is described above regarding FIGS. 3 and 4.

In FIG. 6, The end tip 32 of the punch has moved against the drive block 18 oblique camming end surface, driving the drive mechanism backward thus loading the drive spring 31. As the downward motion of the punch continues, it picks off the nut from its held position in bottom member 10 and moves it down the nosepiece 14. Spring 31 is maximally compressed and a nut 21 has been delivered to the end of the nose piece 14 Thereafter, the punch tip 32 is retracted and the operating cycle is complete.

Referring now to FIGS. 7, functional framework members removed from FIGS. 1 through 6 are shown particularly in relation to the drive mechanism. The drive mechanism is comprised of the drive block 18 which is moved forward by the force of spring 31 which operates between the drive block and end member 8. The drive block 18 is closely fitted above and below by parallel top member 12 and intermediate framework member 85. A housing 87 has a groove with sidewalls that are closely fitted to the sides of the drive block 18. The housing 87 also has an end wall that limits the fully extended position of the drive block. Thus, the drive block 18 is closely confined on five sides and abutted by the drive spring on the remaining sixth side. The top surface of intermediate member 85 provides a floor upon which the bottom of the drive block 18 slides as it traverses back and forth between its extreme positions of extension and retraction. Intermediate framework member 85 has a slot through which the drive pawl assembly 19 extends downwardly which supports the pawl against lateral deflection.

As seen in FIG. 7 the framework members depicted in FIGS. 1 through 8 above can be united forming a complete and fully integrated assembly of layered members sandwiched together. Their means of attachment are well within the understanding of one of skill in the art and therefore no further explanation in that regard is needed.

Referring now to FIG. 8, all major components of the feeder device are shown in this exploded assembly view. It demonstrates how the completed assembly of FIG. 7 are related and can be united. The parts enumerated here are described with like numbering in other figures of drawing without the need for repetition here. The press punch is received in a top guide port 4 of the top plate which has a collar 6 that centers the retraction spring as seen in FIG. 7.

Referring now again to FIG. 9, while only a bottom portion of the tracks are shown in FIG. 3, greater detail of the feeder pathway prior to the separation of the nuts from the carrier strip is shown here. The feeder pathway 88 is a composite of two tracks which begin axially superimposed at an entrance of the track through end framework member 8 as seen as in FIG. 8. One track 25 is a guide track for directing the carrier strip 22 and the second track is a main track channel 88 for directing the nuts 21. Each track is selectively dimensioned to allow passage of one element of the carrier/nut assembly but not the other. Strip guide track slots 25 extend above and below a main pathway channel 88 which is exclusively occupied by the nuts 21. In turn, the grooves are exclusively occupied by the carrier strip. Here, the combined tracks form a cross shape where the guide groove 25 is eclipsed by the central main pathway 88. The main pathway channel has a bottom surface 45 which supports the nuts 21 on the top surface of bottom framework member 10. As seen in FIG. 3, along a separation portion of the composite track, the strip guide track slot diverges from the main track direction through a main track sidewall. The driving force applied to the strip is only by the force on the nuts exerted by the feed wheel without direct engagement with the carrier strip. This action creates a lateral differential separation force between the two components of strip assembly whereafter they continue along their separate tracks: the vacant carrier strip is directed out of the feeder device while the loose nuts in the main track are directed in a channel into the feed wheel containment pockets.

The foregoing is an example of only one embodiment of the invention. There may be other variants of materials and structures which will occur to those of skill in the art from what has been disclosed. It should be understood that the invention and its scope is to be determined solely by the following claims and their legal equivalents.

What is claimed is:

1. A fastener feed device for a punch press, comprising:
a feed device for fasteners on a carrier strip having a framework affixed to the punch press, said feed device comprising a vertical bore at a top end adapted to receive a punch of said punch press, said bore being in vertical alignment with a pickoff site within a bottom member of the framework where the fasteners can be picked off and carried to an installation site where they are installed into a workpiece by the punch;
a feed track on said framework bottom member is constructed to direct a plurality of fasteners held on the carrier strip to the pickoff sit, a separator portion of said track is located upstream of said pickoff site and is constructed to remove individual loose fasteners one-at-a-time from said carrier strip;
a feed wheel rotatably affixed to the framework bottom member operative to pull said carrier strip to successive positions of advancement along said track, said feed wheel having a plurality of teeth with separate containment pockets between them, each pocket adapted to receive one of the fasteners; and
a drive mechanism slidably affixed to the framework and operative to turn said feed wheel whereby individual loose fasteners occupying said feed wheel containment pockets are delivered to the pickoff site, said drive mechanism being driven by direct engagement with the press punch.

2. The fastener feed device of claim 1 wherein the drive mechanism comprises a reciprocal drive block engageable with the feed wheel, said drive block having a cam surface on a distal end that engages the motion of the press punch thereby causing its reciprocal motion between extended and retracted horizontal positions.

3. The fastener feed device of claim 2 further comprising a spring operative against an end of the drive block opposite the cam surface which biases the drive block toward the press punch whereby vertical up and down motion of the punch causes horizontal back and forth motion of the drive block and rotation of the feed wheel.

4. The fastener feed device of claim 3 wherein the drive block has a deflectable pawl that engages upwardly extending lugs on the feed wheel whereby linear motion of the drive block rotates the wheel.

5. The fastener feed device of claim 4 wherein the drive block is closely held above the feed wheel and within walls of a housing which bound its reciprocal path, one wall being a intermediate member of the framework having a slot through which the drive block pawl downwardly extends.

6. The fastener feed device of claim 1 having a sidewall adjacent the periphery of the feed wheel which forms a channel that receives the loose fasteners, said sidewall having a stop surface at the pickoff site which limits the advancement of the loose fasteners and rotation of the feed wheel.

7. The fastener feed device of claim 1 wherein the carrier strip is pulled through the feed device solely by feed wheel rotation and its engagement with the fasteners.

8. The fastener feed device of claim 5 wherein the pawl is spring-biased and vertically deflectable such that the pawl is moved upwardly and over the feed wheel lugs sequentially as the drive block is moved from the extended to the retracted position thereby forming a ratchet mechanism by which the drive block pawl intermittently pushes against the feed wheel turning it in one direction only.

9. The fastener feed device of claim 1 wherein the fasteners are individually held on the carrier strip by tabs which extend from the top and bottom portions of the strip into an internal bore of each fastener whereby the fasteners are secured to the strip more rigidly in axial and vertical planes than in the lateral plane such that the fasteners can be nondestructively removed from the strip when a differential lateral force is applied to the fastener.

10. The fastener feed device of claim 1 wherein the feed track has a separation portion with slots above and below the fasteners which receive the top and bottom ends of the carrier strip respectively, said slots being wider than the carrier strip but narrower than the fasteners whereby the fasteners are laterally forced from the strip at a separation portion of the track where the slots diverge laterally to one side of a fastener pathway thus forming two separate downstream tracks, one occupied by a vacant carrier strip remainder and the other occupied by separated loose fasteners.

11. The fastener device of claim 2 wherein the drive block is reciprocal within a framework housing of the feed device framework that has an end wall which acts as a positive stop to limit the extended position of the drive block.

12. The fastener feed device wherein the feed wheel is rotationally affixed to a framework bottom member by an axle and acting upon the feed wheel is a deflectable spring-biased catch affixed to the framework bottom member which acts upon a backside of the teeth of the feed wheel to prevent the backward rotation of the feed wheel.

13. The fastener feed device of claim 6 wherein a portion of the track sidewall is a side surface of a clamp jaw rotatably affixed to the framework bottom base member such that the fasteners are positively grasped by the clamp jaw at the pickoff site.

14. The fastener feed device of claim 13 wherein the clamp jaw has an arcuate surface with a stop ridge to limit the advancement of the fasteners at the pickoff site.

15. The fastener feed device of claim 1 wherein the feed track bifurcates at a separation point into two separate tracks, one track constructed and adapted to exclusively guide the carrier strip and the other track being a channel constructed to guide loose fasteners separated from the carrier strip at the separation point.
